(19) United States
(12) Patent Application Publication
(10) Pub. No.: US 2006/0050871 A1
(43) Pub. Date: Mar. 9, 2006

(54) Method and apparatus for securing data stored within a non-volatile memory

(76) Inventors: Ohad Ranen, Tel Aviv (IL); Leddor Agam, Savion (IL); Yanki Margalit, Ramat-Gan (IL); Dany Margalit, Ramat-Gan (IL)

Correspondence Address: DR. MARK FRIEDMAN LTD.;c/o Bill Polkinghorn, 9003 Florin Way, Upper Marlboro, MD, 20772, US

(21) Appl. No.: 10/934,477

(22) Filed: Sep. 7, 2004

(51) Int. Cl. H04K 1/06

(52) U.S. Cl. 380/37

(57) ABSTRACT

A method for securing data of a non-volatile memory device, comprising: providing the non-volatile memory device with a secured chip, for securely storing a secret for ciphering/deciphering the data; providing the non-volatile memory device with a ciphering/deciphering logic, for ciphering/deciphering the data with a secret; storing a secret for ciphering/deciphering the data within the secured chip; on storing data within the non-volatile memory device, employing the secret from the secured chip, and ciphering the data with the secret; and on retrieving data from the non-volatile memory device, employing the secret from the secured chip, and deciphering the encrypted data with the secret.

### FIELD OF THE INVENTION

The present invention relates to the field of data security. More particularly, the invention relates to a method and apparatus for securing data stored within a non-volatile memory.

### BACKGROUND OF THE INVENTION

Flash memory is a type of nonvolatile memory that can be erased and reprogrammed. It is a variation of electrically erasable programmable read-only memory (EEPROM), which is slower than flash memory updating. One of the earliest implementations of a flash memory was for holding control code such as the basic input/output system (BIOS) in a personal computer. When BIOS needed to be changed (rewritten), the flash memory could be written to in block (rather than byte) sizes, making it easy to update (a block can be considered as a fixed size chunk of data, which its size is determined according to physical reasons, programmable reasons, or even is determined arbitrarily).

Currently flash memory is commonly used in cellular phones, digital cameras, LAN switches, PC Cards for notebook computers, digital set-up boxes, embedded controllers, and so forth.

One of the most popular devices based on flash memory is the USB flash drive. It is a small, portable card that plugs into a computer's USB connector, and functions as a portable drive which currently can have up to 2 GB of storage capacity. USB flash drives are considered as being easy-to-use, small enough to be carried in a pocket, and can plugged into any computer with a USB drive. USB flash drives have less storage capacity than an external hard drive, but they are smaller and more durable because they do not contain any internal moving parts like a magnetic disk. USB flash drives also are also called pen drives, key drives or simply USB drives.

“Compact flash” is a well known format of flash memory, which is very common in digital cameras. Yet another format of flash memory is the “SD Card”, a miniaturized format of flash card, which is of a Size of postage stamp at only 2 gr., designed to comply with current and future SDMI (Secure Digital Music Initiative) portable device requirements. Yet another type of flash memory is the “SmartMedia”, designed for use with digital still cameras, PDA's, MP3 players and other electronic products that use SmartMedia cards as standard or extended data storage. Yet another example is the “Multimedia Card”, with a size of postage stamp at only 2 gr. designed to allow to easily uploading, downloading, storing and capturing of images, music and data in digital camera, audio player, PDA or other handheld devices. These non-volatile, durable cards are designed to perform over a wide temperature range while being extremely shock resistant.

From the user's point of view, upon inserting a USB flash drive into a USB connector of a computer, the user gets access to a disk drive. Thus, the user can store and retrieve files from the USB flash drive. As such, USB flash drives are used as personal storage means. For example, a user that stores some of his personal files on a USB flash drive can use these files at the office as well as at home.

Due to their portable nature, USB flash drives have a security fault, since losing a USB flash drive can result not only in losing the stored data, but also in the data falling into wrong hands.

Therefore, it is an object of the present invention to provide a method and apparatus for securing data stored within a non-volatile memory device.

Other objects and advantages of the invention will become apparent as the description proceeds.

### SUMMARY OF THE INVENTION

In one aspect, the present invention is directed to a method for securing data on a non-volatile memory device, the method comprising the steps of: providing the non-volatile memory device with a secured chip, for securely storing a secret for ciphering/deciphering the data; providing the non-volatile memory device with a ciphering/deciphering logic, for ciphering/deciphering the data with a secret; storing a secret for ciphering/deciphering the data within the secured chip; on storing data within the non-volatile memory device, employing the secret from the secured chip, and ciphering the data with the secret; and on retrieving data from the non-volatile memory device, employing the secret from the secured chip, and deciphering the encrypted data with the secret.

According to another aspect, the present invention is directed to a non-volatile memory device, for securely storing data, the non-volatile memory device comprising: a non-volatile memory, for storing data; a secured chip, for securely storing a secret for ciphering and deciphering the data; and ciphering/deciphering logic, for ciphering and deciphering the data using the secret. The non-volatile memory device may further comprise communication means to a host (e.g. USB, WiFi, Bluetooth, infrared, radio frequency, serial communication, and parallel communication).

### BRIEF DESCRIPTION OF THE DRAWINGS

The present invention may be better understood in conjunction with the following figures:

FIG. 1 schematically illustrates an NVMD, according to the prior art.

FIG. 2 schematically illustrates an NVMD, according to a preferred embodiment of the invention.

FIG. 3 schematically illustrates an NVMD, according to another preferred embodiment of the invention.

FIG. 4 schematically illustrates an NVMD, according to another preferred embodiment of the invention.

FIG. 5 schematically illustrates an NVMD, according to yet another preferred embodiment of the invention.

FIG. 6 schematically illustrates an NVMD, according to still another preferred embodiment of the invention.

### DETAILED DESCRIPTION OF PREFERRED EMBODIMENTS

The term Non-Volatile Memory Device (NVMD) refers herein to a device comprising non-volatile memory storage. NVMD can be implemented in a variety of ways, such as non-volatile memory (e.g. flash memory) connected to a bus of another device; as a small and portable device that plugs into a host (e.g. personal computer) by wired (e.g. USB, RS232, printer's port) or wireless (e.g. infrared such as IrDA, RF such as Bluetooth) means, and so forth.

USB flash drive is an example of an NVMD. Also the Puppy (manufactured by Sony), Disk-On-Key manufactured by M-Systems, are examples of NVMD.

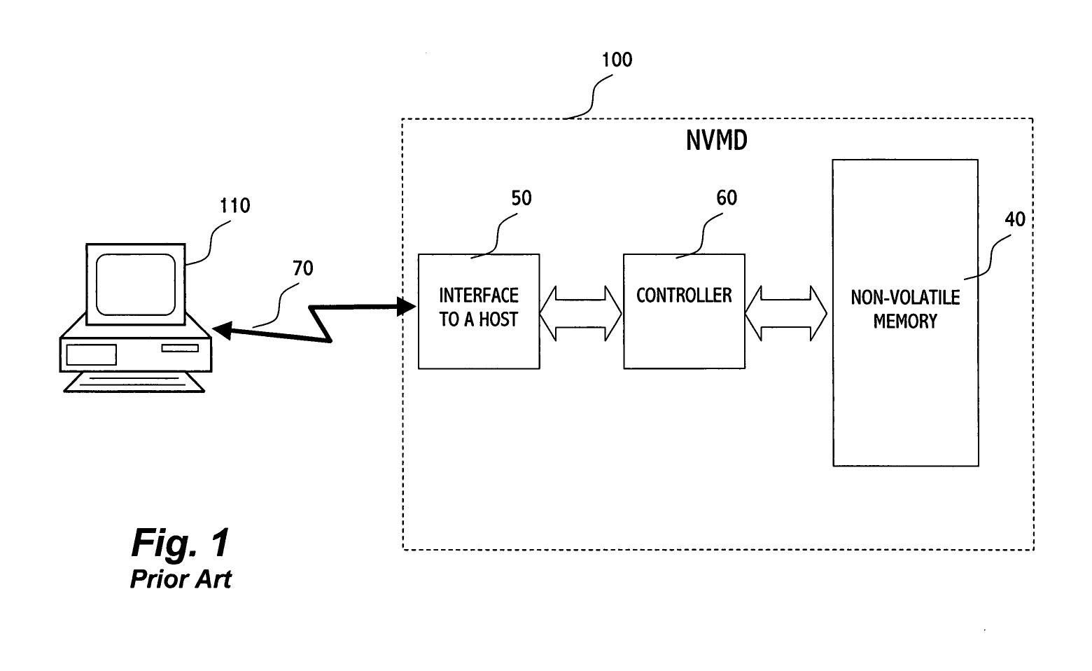

FIG. 1 schematically illustrates an NVMD, according to the prior art. NVMD 100 is connected to a host 110 via communication channel 70. The NVMD 100 comprises non-volatile memory 40 (e.g. Flash memory), and interface 50 (e.g. USB) to host 110. The operation of the NVMD 100 is controlled by a controller 60, such as Cypress, Cygnal.

The term Non-Volatile Device refers herein to an apparatus comprising non-volatile memory. For example, NVMD is a private case of a non-volatile memory device. In order to facilitate the description herein, the examples herein refer usually to NVMD, however it should be noted that the description is directed to any kind of non-volatile device, including NVMD. For example, a BIOS based on flash memory also falls within the definition of non-volatile memory devices. A digital camera which stores the captured images in a flash memory also falls within the definition of non-volatile memory device. A non-volatile device may further comprise communication means with another device, such as a host.

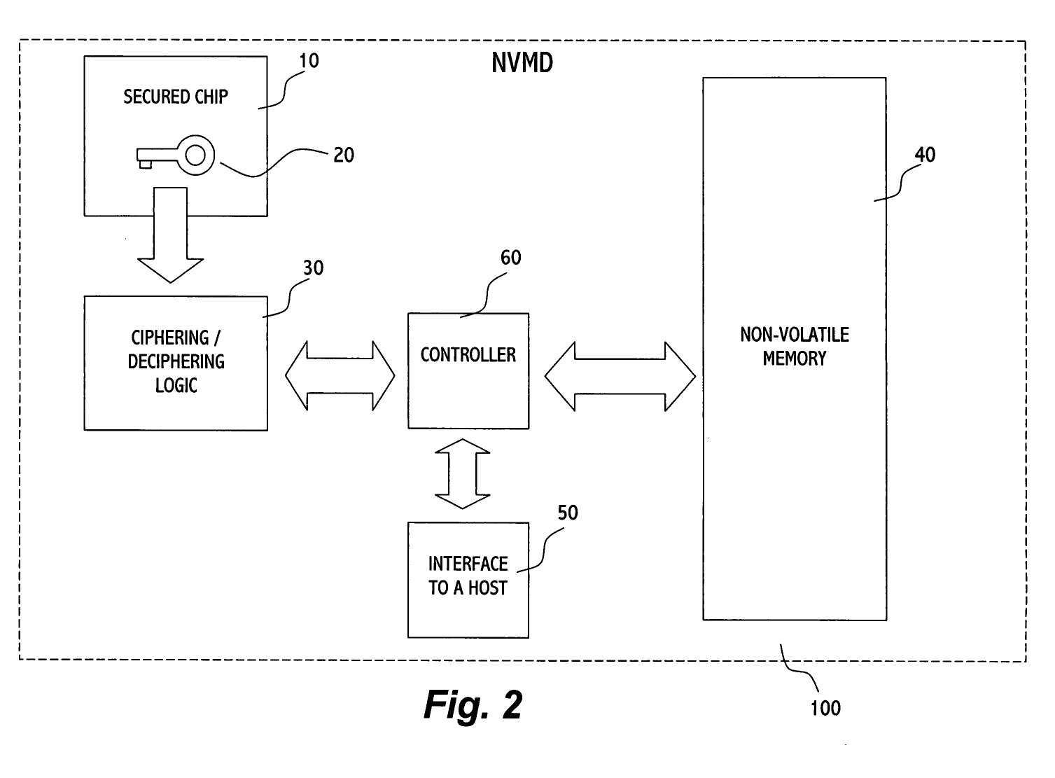

FIG. 2 schematically illustrates an NVMD, according to a preferred embodiment of the invention. An NVMD 100 comprises non-volatile memory 40, such as flash memory, EEPROM, and so forth. NVMD 100 comprises a secured chip 10, and ciphering/deciphering logic 30. A secret 20, e.g. a ciphering key, is stored within the secured chip 10.

Protecting data stored within the non-volatile memory 100 is carried out by the ciphering logic 30, which implements the secret 20 for this purpose. Since the secret 20 is stored within a secured chip, the effort required to expose the secret is actually the effort required to “hack” the secured chip, and since secured chips are designed to prevent exposing their content, the effort to expose the secret 20 is substantial.

The term “secured chip” refers herein to a microelectronics circuitry for storing information (e.g. data and applications) in a protected form. Smart card chip is an example of a secured chip. The term “secured device” refers herein to a hardware device coupled with a secured chip. Smart card is an example to a secured device.

A secured device interacts with other devices by physical contact between dedicated conductive parts of the secured device and the other devices. This functionality is provided also by a secured device reader, a small device into which both, the secured device and the other device, are connected. The other device usually connects to the secured device reader by a common interface, such as USB.

In order to get services from a secured device, a client has to share a secret with the secured device. Thus, when a client asks for a service from a secured device, it should present to the secured device a PIN, password, etc. This is referred in the art as Access Condition.

There are two common physical ways of contact between a secured device and a reader (or other device); “landing” contact and “friction” contact (also known as sliding or wiping). In general, card reader of landing type provides better protection to the card than that of the friction type.

Nowadays a high level specification to secured devices is provided, e.g. ISO7816 for electrical contacts, ISO7810 (ID-1) for physical characteristics, etc. Secured devices operate with dedicated operating system, such as MULTOS.

As a computerized system, a secured device has a CPU chip (such as of Infineon, Amtel, Hitachi, Phillips) and memory, usually of EEPROM. Nowadays the size of the memory of a secured device is about 64 KB.

Typically, data of a file system mechanism is written/read in blocks, especially when the mechanism is based on flash memory. According to one embodiment of the invention, prior to writing a block, the block is ciphered, and after the block is retrieved, the block is deciphered.

The ciphering/deciphering operation is carried out by the ciphering/deciphering mechanism 30, using the key(s) 20 stored within the secured chip 10. Of course the ciphering mechanism and the deciphering mechanism can be separate entities.

Typically, the ciphering/deciphering mechanism is based on software (computer code), however it can be based also on hardware (shift operations, XOR, etc.), and also on the combination of both.

According to another embodiment of the invention, instead (or in addition) to ciphering/deciphering of blocks, the ciphering/deciphering operation can be carried out on a file basis. For example, a file that has been copied to or created on the NVMD is encrypted after being used, and decrypted before being used.

According to another embodiment of the invention, the ciphering/deciphering is based on a chunk of data of a certain size, of a chunk of data of variable size, etc.

According to another embodiment of the invention, additionally or alternatively to ciphering/deciphering blocks, the order of the blocks on the memory 40 is “scrambled”, i.e. the blocks are stored in a pseudo-random order, while the block table (known in the art as FAT—File Allocation Table) is kept within the secured chip 10.

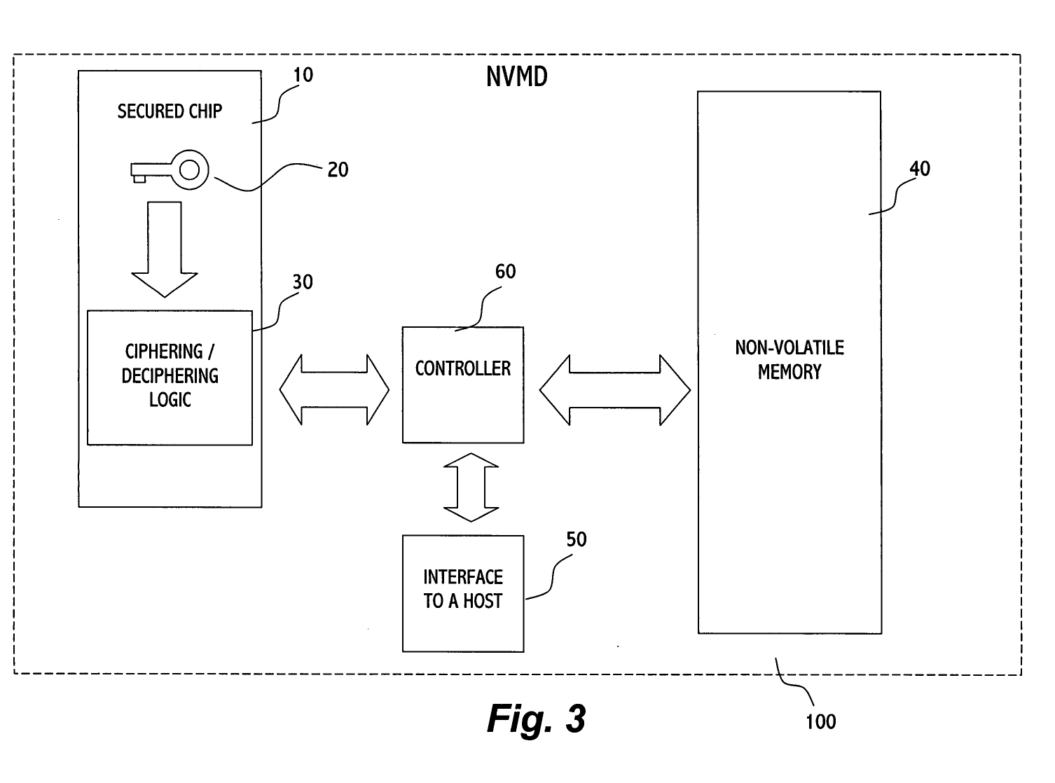

FIG. 3 schematically illustrates an NVMD, according to another preferred embodiment of the invention. As illustrated in FIG. 3, the ciphering/deciphering logic 30 is embedded within the secured chip 10. For example, the ciphering/deciphering operations are carried out by the programming tools of the secured chip 10.

The ciphering/deciphering operations may be based on symmetric methods (e.g. private-key), asymmetric methods (e.g. public-key), one-time-password methods, RSA, etc.

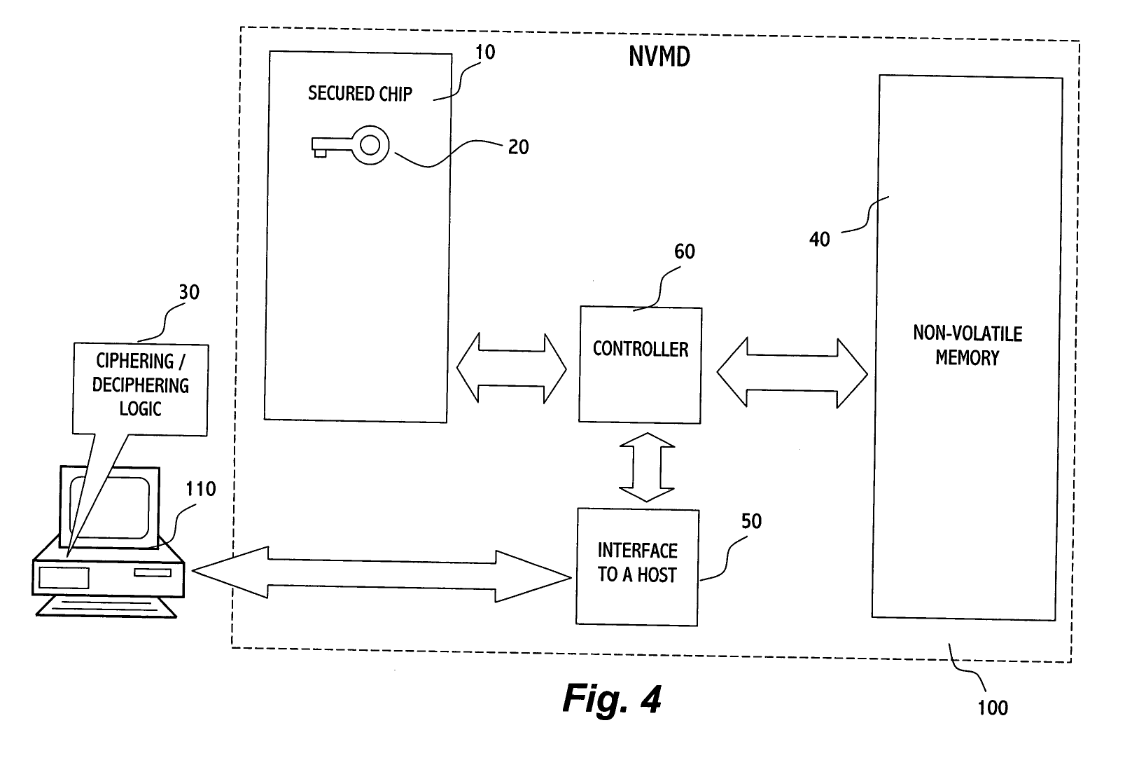

FIG. 4 schematically illustrates an NVMD, according to yet another preferred embodiment of the invention. The encryption logic 30 resides on the host 110, while the secured chip 10 stores only the keys 20.

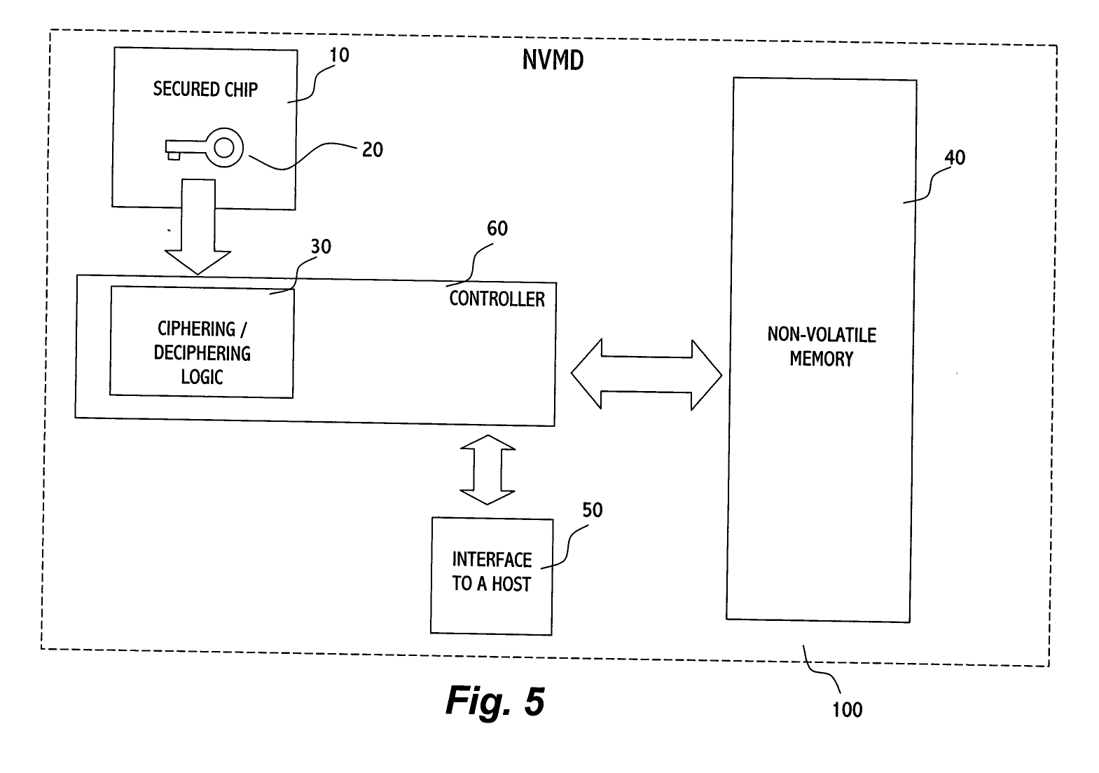

FIG. 5 schematically illustrates an NVMD, according to still another preferred embodiment of the invention. According to this embodiment, the encryption logic 30 is a part of the controller 60.

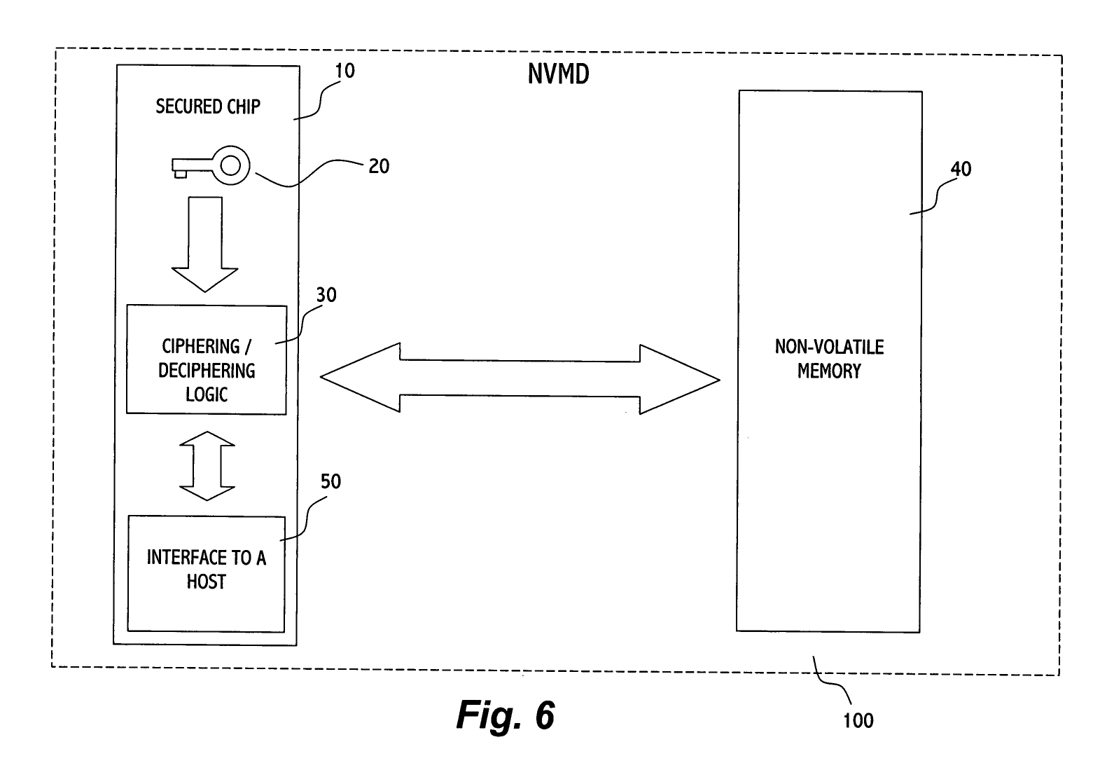

FIG. 6 schematically illustrates an NVMD, according to still another preferred embodiment of the invention. According to this embodiment, the encryption logic 30 and the interface to a host 50 are a part of the secured chip 10.

It should be noted that an NVMD can be also in a form of a secured device, e.g. a credit-card-sized device with embedded microelectronics circuitry for storing information about an individual. An NVMD can also be of a form of a security token, i.e. a small hardware device that the owner carries with in order to authorize access to a service, e.g. Aladdin eToken™, Rainbow, iKey™, a key fob, etc.

Those skilled in the art will appreciate that the invention can be embodied by other forms and ways, without losing the scope of the invention. The embodiments described herein should be considered as illustrative and not restrictive.

1. A method for securing data stored on a non-volatile memory device, the method comprising the steps of:
providing said non-volatile memory device with a secured chip, for securely storing a secret for ciphering/deciphering said data;
providing said non-volatile memory device with a ciphering/deciphering logic, for ciphering/deciphering said data with said secret;
storing a secret for ciphering/deciphering said data within said secured chip; and
on storing data within said non-volatile memory device, employing said secret from said secured chip, and ciphering said data with said secret.

2. A method according to claim 1, further comprising the step of: on retrieving data from said non-volatile memory device, employing said secret from said secured chip, and deciphering the encrypted data with said secret.

3. A method according to claim 1, wherein said secured chip is a smart card chip.

4. A method according to claim 1, wherein said secured chip is a chip manufacturered by a company selected from a group comprising: Infineon, Amtel, Hitachi, and Phillips.

5. A method according to claim 1, wherein said ciphering/deciphering logic is embedded within a member of a group consisting of: said secured chip, said non-volatile memory device, a controller of said non-volatile memory device, a host upon which said non-volatile memory device is connected to.

6. A method according to claim 1, wherein said ciphering/deciphering operates on a member selected from the group comprising: a block, a file, a chunk of data, a chunk of data of a fixed size, a chunk of data of variable size.

7. A method according to claim 1, wherein said ciphering/deciphering is carried out by a member of a group comprising: software, hardware, software and hardware.

8. A method according to claim 1, wherein said memory is managed by a file allocation table.

9. A method according to claim 8, wherein said file allocation table is stored within said secured chip.

10. A method according to claim 8, wherein said memory is kept scrambled.

11. A non-volatile memory device, for securely storing data, said non-volatile memory device comprising:
a non-volatile memory, for storing data;
a secured chip, for securely storing a secret for ciphering and deciphering said data; and
ciphering/deciphering logic, for ciphering and deciphering said data using said secret.

12. A non-volatile memory device according to claim 11, further comprising communication means with a host.

13. A non-volatile memory device according to claim 11, wherein said secured chip is manufactured by a company selected from a group comprising: Infineon, Amtel, Hitachi, Phillips.

14. A non-volatile memory device according to claim 11, wherein said ciphering/deciphering logic is embedded or resides within a member of a group consisting of: said secured chip, said non-volatile memory device, a controller of said non-volatile memory device, a host upon which said non-volatile memory device is connected to.

15. A non-volatile memory device according to claim 11, wherein said ciphering/deciphering operates on a member selected from the group comprising: a block, a file, a chunk of data, a chunk of data of a fixed size, a chunk of data of variable size.

16. A non-volatile memory device according to claim 11, wherein said ciphering/deciphering is carried out by a member of a group comprising: software, hardware, software and hardware.

17. A non-volatile memory device according to claim 11, wherein said memory is managed by a file allocation table.

18. A non-volatile memory device according to claim 17, wherein said file allocation table is stored within said secured chip.

19. A non-volatile memory device according to claim 17, wherein said memory is kept scrambled.

20. A non-volatile memory device according to claim 11, wherein said device is of a form selected from a group comprising: security token, secured device, key fob.

21. A non-volatile memory device according to claim 12, wherein said communication means with a host is selected from a group comprising: USB, WiFi, Bluetooth, infrared, radio frequency, serial communication, and parallel communication.
